(19) United States
(12) Patent Application Publication
(10) Pub. No.: US 2009/0169074 A1
(43) Pub. Date: Jul. 2, 2009

(54) SYSTEM AND METHOD FOR COMPUTER ASSISTED ANALYSIS OF MEDICAL IMAGE

(75) Inventors: Gopal Avinash, Menomonee Falls, WI (US); Kiran Panchal, Bangalore (IN)

Correspondence Address: PETER VOGEL;GE HEALTHCARE, 20225 WATER TOWER BLVD., MAIL STOP W492, BROOKFIELD, WI, 53045, US

(73) Assignee: GENERAL ELECTRIC COMPANY, Schenectady, NY (US)

(21) Appl. No.: 11/968,476

(22) Filed: Jan. 2, 2008

(51) Int. Cl. G06K 9/00

(52) U.S. Cl. 382/128

(57) ABSTRACT

In one embodiment, a computer assisted method for displaying a medical image is provided. The method comprises steps of determining authorization status of a user accessing an image database, suppressing the information content in a first image, commensurate with the authorization status, to obtain a second image and displaying the second image to the user.

### FIELD OF THE INVENTION

The invention relates to the development of computer assisted diagnostic (CAD) methods for the processing of digital images. More particularly, the invention relates to the use of CAD methods for the detection and suppression of one or more regions of interests (ROIs) within a medical image.

### BACKGROUND OF THE INVENTION

In many media situations, there is a need for suppressing certain information from being displayed. A good example for such a situation is suppression of offensive material (e.g., nudity) from being displayed during a newscast. Typically, in a media production environment, such tasks are accomplished by manual blurring of one or more offensive regions.

In medical situations, there exist a number of cases where certain information may be intentionally suppressed. For example, in a HIPAA (Health Insurance Portability and Accountability Act) compliant environment, an unauthorized person may be prevented from viewing certain features of the images to prevent misuse of the information content but yet provide a general view of the image to assist in browsing. In another example, when required by law, a display of real-time ultrasound exam of a fetus can be designed to suppress sex determination task, by selectively blurring images of genitals of the fetus. Hence, in general, for legal compliancy, there exists a need for selective suppression of ROIs in the medical images, while making the process of suppression not too intrusive and/or labor intensive.

### BRIEF DESCRIPTION OF THE INVENTION

The above-mentioned shortcomings, disadvantages and problems are addressed herein which will be understood by reading and understanding the following specification.

In one embodiment, a computer assisted method for displaying a medical image is provided. The method comprises steps of determining authorization status of a user accessing an image database, suppressing the information content in a first image, commensurate with the authorization status, to obtain a second image and displaying the second image to the user.

In another embodiment, a method for analyzing a medical image is provided. The method comprises acquiring a first image from an imaging system, determining an authorization status of a user accessing the first image, suppressing the information content in the first image, commensurate with the authorization status, to obtain a second image and displaying the second image to the user.

In yet another embodiment, a system for computer assisted analysis of medical image is provided. The system comprises, a source, a detector, a data acquisition system, a computer system operably coupled to the data acquisition system, an operator workstation and a memory element. The computer system is configured to acquire a first image from the detector, determine an authorization status of a user accessing the first image, suppress the information content in the first image, commensurate with the authorization status, to obtain a second image and display the second image to the user.

In yet another embodiment, a tangible medium comprising program code for executing an image processing method for an imaging system is provided. The method comprises a routine for determining authorization status of a user accessing an image database, a routine for suppressing the information content in a first image, commensurate with the authorization status, to obtain a second image and a routine for displaying the second image to the user.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a flow diagram of a computer assisted method for displaying a medical image in an embodiment of the invention;

FIG. 2 shows a flow diagram of a method of suppressing the information content in one embodiment of the invention;

FIG. 3 shows a flow diagram of a method of suppressing the information content in another embodiment of the invention;

FIG. 4 shows a flow diagram of a method of suppressing the information content in yet another embodiment of the invention;

FIG. 5 shows a flow diagram of a method for processing a medical image in an embodiment of the invention;

FIG. 6 shows a flow diagram of a method for feature classification in an embodiment of the invention;

FIG. 7 shows a block diagram of a system for computer assisted analysis of medical image; and

FIG. 8 shows a flow diagram of a method for analyzing a medical image in an embodiment of the invention.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

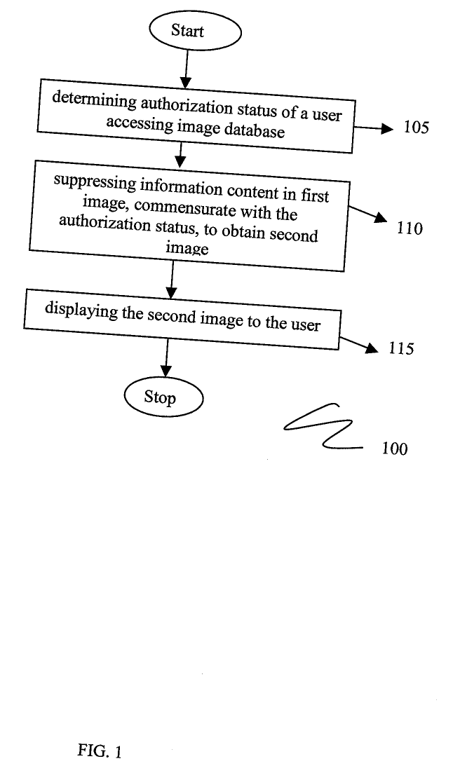

In one embodiment, as shown in FIG. 1, a computer assisted method 100 for displaying a medical image is provided. The method 100 comprises steps of determining authorization status of a user accessing an image database (block 105), suppressing the information content in a first image, commensurate with the authorization status, to obtain a second image (block 110) and displaying the second image to the user (block 115).

The process of determining authorization status (block 105) can be done in any one of the known ways of authenticating the authorization for a given dataset including password-protected access and biometric based access.

In one embodiment, the authorization step can be incorporated prior to image visualization, which is either by accessing an image database or by acquiring a real-time image. In an alternate embodiment, an unauthorized person i.e, a user without an authorization is allowed to view an image with the information content suppressed. This enables the unauthorized user to access at least a part of the image to obtain a general idea of the information content.

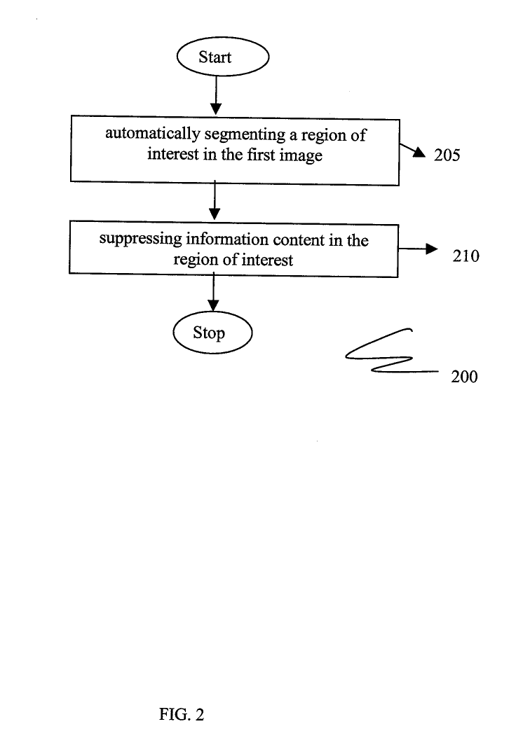

Accordingly, suppressing the information content (block 110) in a medical image can be carried out in a number of ways as explained in conjunction with FIGS. 2, 3 and 4. In one embodiment, as shown in FIG. 2, the method 200 of suppressing the information content comprises automatically segmenting at least one region of interest in the first image (block 205) and suppressing the information content in the region of interest (block 210).

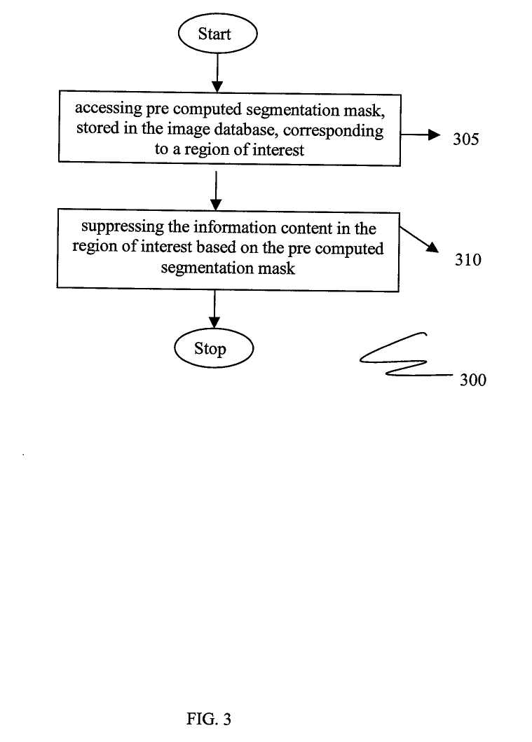

In another embodiment, as shown in FIG. 3, the method 300 of suppressing the information content comprises accessing a pre computed segmentation mask corresponding to at least one region of interest (block 305) and suppressing the information content in the region of interest based on the pre computed segmentation mask (block 310). Further, the pre computed segmentation mask is stored in the image database and is chosen based on the authorization status.

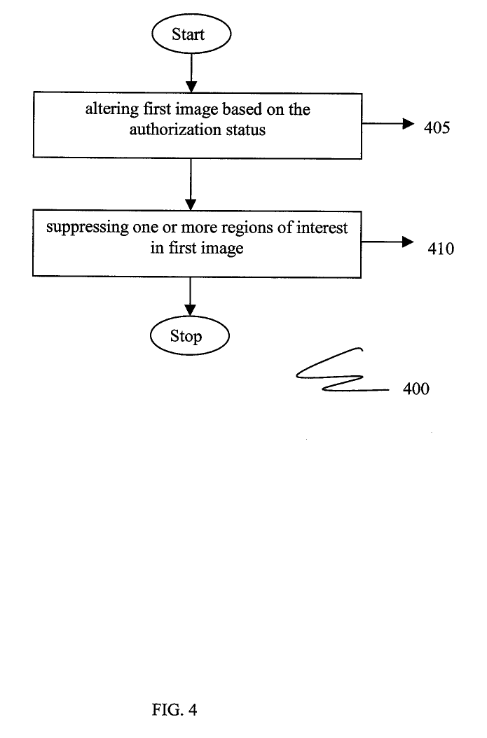

In yet another embodiment shown at FIG. 4, the method 400, of suppressing the information content comprises altering the first image based on the authorization status (block 405) and suppressing one or more regions of interest in the first image (block 410).

Skilled artisans shall however appreciate that the methods 200, 300 and 400 of suppressing the information content described in conjunction with FIGS. 2, 3 and 4 are not limited to the examples and the invention encompasses full scope of the claims.

Automated segmentation (block 205) of features can be accomplished in many ways. It may be, for example, based on the shape, intensity texture, prior knowledge, atlas, and image understanding techniques.

The suppression of selected regions (block 210) can be carried out in any one of known methods to make the unauthorized data not discernible. Examples of the known methods include blurring the segmented feature of interest beyond recognition by smoothing or pixelating, or color-coding the region to restrict the information content provided to the unauthorized user.

In the automated segmentation, a region of interest (ROI) can be defined to calculate features in the image data. The region of interest can be defined in several ways using the entire data set or using a part of the data. Several techniques or their combinations can be used for this purpose including but not limited to iterative thresholding, k-means segmentation, edge detection, edge linking, curve fitting, curve smoothing, 2D/3D morphological filtering, region growing, fuzzy clustering, image/volume measurements, heuristics, knowledge-based rules, decision trees, neural networks. An automated segmentation algorithm can use prior knowledge such as the shape and size of a mass to automatically delineate the region of interest.

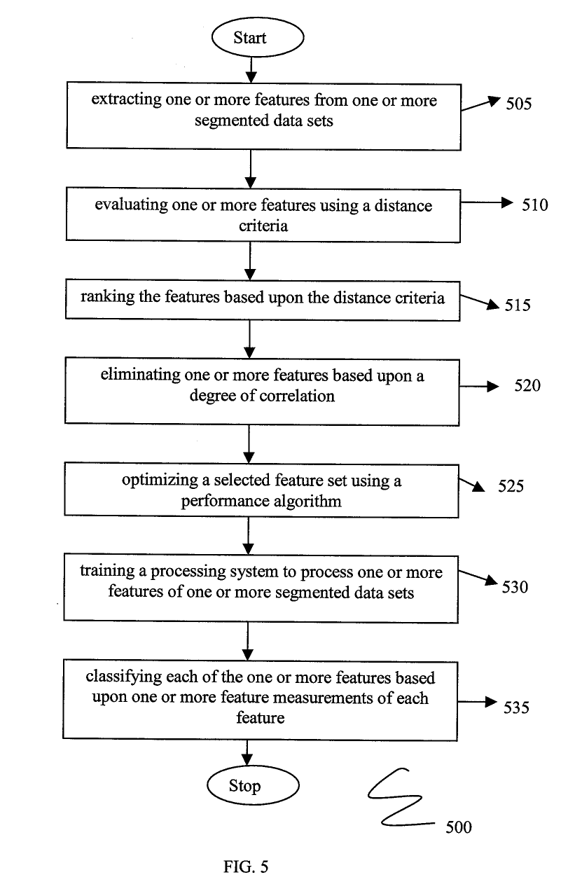

Automated segmentation is followed by feature processing. Feature processing 500 as described in FIG. 5, involves one or more of feature extraction (block 505), feature evaluation (block 510), feature ranking (block 515), feature elimination (block 520), feature selection or optimization (block 525), training (block 530) and feature classification (block 535).

Feature extraction (block 505) is a technique that, in effect, combines the feature images to generate a smaller but more effective set of feature images. Thus, the feature extraction process (block 505) involves performing computations on the medical image-based data. Multiple feature measures can be extracted from the image-based-data using region of interest statistics such as shape, size, texture, intensity, gradient, edge strength, location, proximity, histogram, symmetry, eccentricity, orientation, boundaries, moments, fractal dimensions, entropy, density, curvature etc. For a transformation-based data, features such as location, shape, size of feature projection in a view or location, and consistency from view-to-view may be extracted from the dataset. Other information that can be used for feature extraction (block 505) includes acquisition-based information (e.g., kVp, dose) and patient-based information (e.g., age, gender, smoking history, clinical purpose).

Further, it should be noted that the feature extraction techniques are well-known alternatives to feature selection techniques. It should be also appreciated that there are a variety of feature selection techniques usable by the systems and methods provided in this invention, as will be apparent to one skilled in the art.

The feature-extracted data (block 505) may then undergo a feature evaluation process (block 510) whereby the extracted features are evaluated in terms of their ability to separate the different classification groups using distance criteria. Several different distance criteria can be used (e.g., divergence, Bhattacharya distance, Mahalanobis distance) though those skilled in the art will be familiar with other possible distance criteria. Subsequent to the feature evaluation process (block 510), the features are ranked based on the distance criteria (block 515).

Subsequent to the feature ranking process (block 515), the data set may be processed to eliminate correlated features (block 520) by a dimensionality reduction process. In this manner, a large number of identified features may be reduced to a smaller number by eliminating those features deemed to be highly correlated with other features present in the data set. This may result in minimization of duplicative analysis and further reduction of feature set to a manageable number for subsequent automated processes.

Following the elimination of correlated features (block 520), a feature optimization process (block 525) is applied to the remaining feature. A typical feature optimization process (block 525) may consist of creating a selected feature set beginning with a highest ranked feature, from ranking process (block 515), and adding features to the set based upon descending rank. When performance of the feature set, as determined by an optimizing criteria or algorithm, is no longer improved by the addition of features, the feature set is determined and additional features are not added to the set.

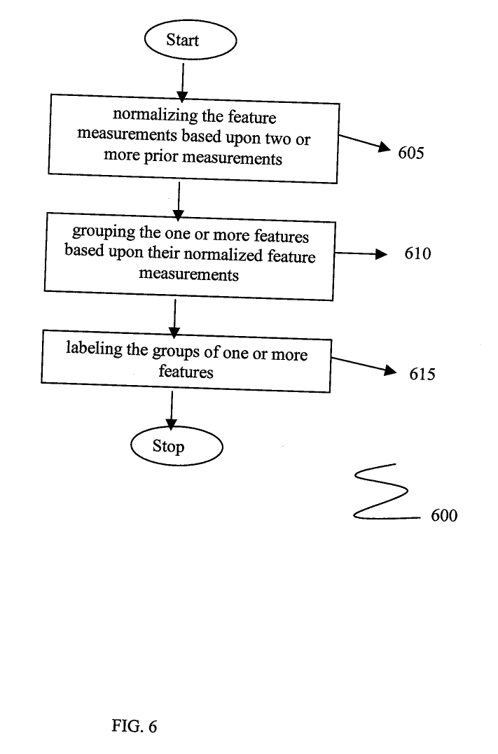

Once the features are computed, a pre-trained classification algorithm (block 535) can be used to categorize the regions of interest into authorized and unauthorized regions. The feature classification process is depicted in FIG. 6. The feature classification process 600 involves normalization of feature measures with respect to feature measures derived from a database of known authorized and unauthorized regions of interest (block 605). Normalized feature measures are grouped (block 610) using one of several techniques available (e.g., decision tree classifier, discriminant function analysis, Bayes' minimum-risk method, clustering techniques, similarity measure approach, pattern recognition techniques, neural networks, rule-based methods, fuzzy logic etc.). Classified feature clusters are labeled (block 615) and saved in a database for future use.

Both the feature extraction process (block 505) and the feature classification process (block 600) discussed above may be modified or enhanced by a training process (block 530 shown in FIG. 5). The training process (block 530) utilizes many of the processes of the feature extraction process (block 505) to process known samples of authorized and unauthorized features. The training process (block 530) thereby incorporates prior knowledge into the feature extraction (block 505). The prior knowledge available to the training process (block 530) may be provided in the form of training parameters which may include, but are not limited to, expert input, acquisition parameters, situational variables, and alternative procedure results, e.g., biopsy.

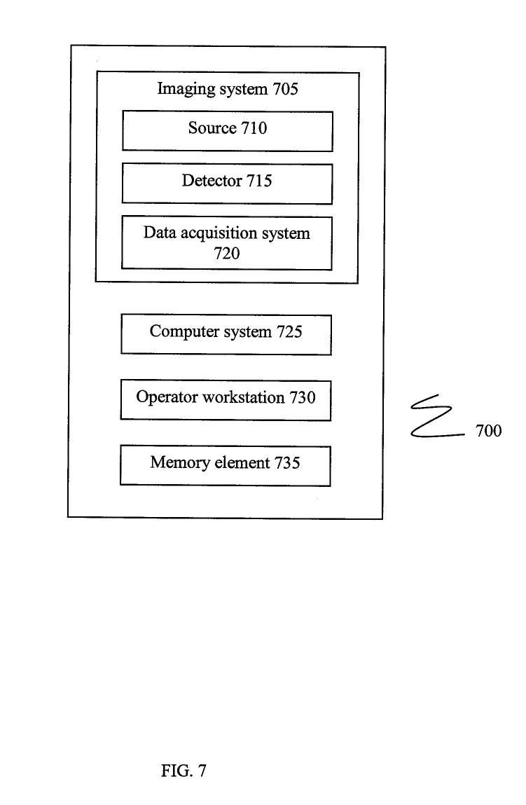

As described above image visualization by a user is carried out either by accessing an image database or by acquiring a real-time image using an imaging system. A medical image thus acquired is analyzed using a system configured for computer assisted analysis of the medical image. FIG. 7 illustrates diagrammatically the system 700 configured for computer assisted analysis of a medical image. The system 700 includes an imaging system 705 configured for imaging objects. The imaging system 705 comprises a source 710, a detector 715 and a data acquisition system 720. The source 710 generates sound waves for projection towards an object to be scanned. The high frequency sound waves incident on the object being scanned are reflected by the internal organs, fluids and tissues of the object. The detector 715 records tiny changes in the pitch and direction of the high frequency sound waves. These signature waves are instantly measured and displayed by the data acquisition system (DAS) 720 on a computer, which in turn creates a real-time picture on the monitor.

A computer system 725 is operably coupled to the data acquisition system 720, an operator workstation 730, a memory element 735, and to one or more output devices (not shown). The computer system 725 is configured to acquire a first image from the imaging system 705, determine an authorization status of a user accessing the first image, suppress the information content in the first image, commensurate with the authorization status, to obtain a second image and display the second image to the user. The computer system 725 is further configured to process one or more features of the one or more segmented data sets to produce one or more feature-processed data sets.

In one illustrated embodiment, the system 705 configured for acquiring and processing the medical image includes a computed tomography (CT) system designed both to acquire the medical image data and to process the medical image data for display and analysis. Alternative embodiments of system 705 may include an ultrasound imaging system, a positron emission tomography (PET) system, a nuclear medicine imaging system, a thermoacoustic tomographic imaging system (TCT), an electrical impedance system (EIT), near-infrared systems (NIR), and X-ray tomosynthesis systems (XR).

As shown in FIG. 7, the computer system 725 is typically coupled to the data acquisition system 720. The data collected by the data acquisition system 720 may be transmitted to the computer system 725 and moreover, to a memory element 735 coupled to the computer system 725. It should be understood that any type of memory element 735 configured to store a large amount of data may be utilized. Also the computer system 725 is configured to receive commands and scanning parameters from an operator via the operator workstation 730, typically equipped with a keyboard and other input devices. An operator may control the system 700 via the input devices. Thus, the operator may observe the processed image and other data relevant to the system 700 from the computer system 725, initiate imaging, and so forth.

A display (not shown) coupled to the operator workstation 730, may be utilized to observe the processed image and to thereby control imaging. Additionally, the processed image may also be printed on to a printer, which may be coupled to the computer system 725 and/or to the operator workstation 730. Further, the operator workstation 730 may also be coupled to a picture archiving and communications system (PACS). It should be noted that PACS may be coupled to a remote system, radiology department information system (RIS), hospital information system (HIS) or to an internal or external network, so that others at different locations may gain access to the medical image and/or to the image database. Further, the processed images can also be stored or transmitted electronically to another site by any of the methods known in the art.

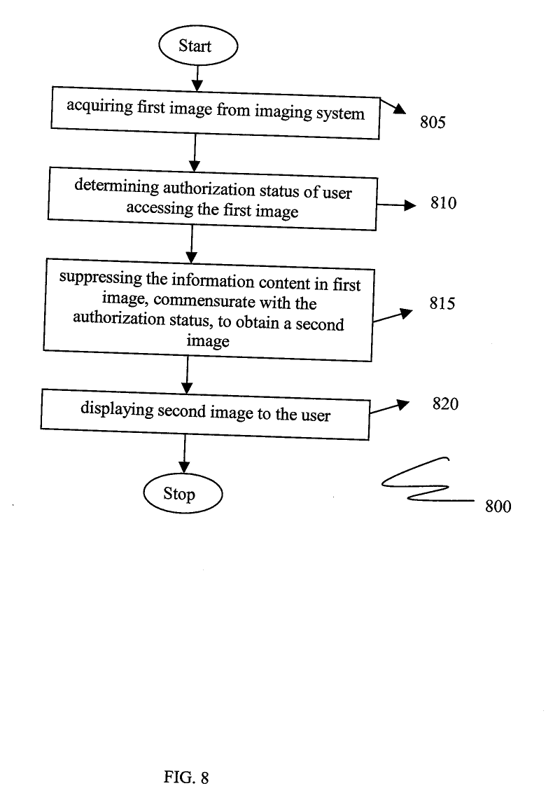

In one embodiment as shown in FIG. 8, a method 800 is provided for analyzing a medical image acquired by the imaging system 705. The method 800 includes acquiring a first image from the imaging system 705 (block 805), determining an authorization status of a user accessing the first image (block 810), suppressing the information content in the first image, commensurate with the authorization status, to obtain a second image (block 815) and displaying the second image to the user (block 820).

In yet another embodiment, the invention provides a tangible medium storing a program code for executing an image processing method for a medical image acquired by the imaging system 705. The programming code stored on the tangible medium includes a routine for determining authorization status of a user accessing the image database, a routine for suppressing the information content in a first image, commensurate with the authorization status, to obtain a second image and a routine for displaying the second image to the user.

CAD algorithms may be considered as including several parts or modules, all of which may be implemented as depicted in FIG. 5. Following the image acquisition, the CAD algorithm may be automatically implemented to process the acquired medical image data set.

The segmentation portion of the CAD algorithm may identify a particular region of interest based upon calculated features in all or part of the medical image data set. Prior to identifying the region of interest, the image data may be pre-processed. Preprocessing may include various data manipulations such as dynamic range adjustment, contrast enhancement, noise reduction, smoothing, sharpening and other types of filtering (e.g. low pass, high pass, band pass).

Subsequent to pre-processing, the region of interest can be determined in a plurality of methods, using an entire data set or using part of a data set, such as a candidate mass region, a stellate lesion, or a micro-calcification. The CAD technique may employ segmentation algorithms, which identify the features of interest by reference to known or anticipated image characteristics, such as edges, identifiable structures, boundaries, changes or transitions in colors or intensities, changes or transitions in spectrographic information, and so forth.

The segmented data set undergoes feature extraction, described in greater detail by reference to FIG. 5. The feature extraction aspect of the CAD algorithm involves performing computations on the medical image data. Multiple feature measures can be extracted from the image-based data-using region of interest statistics, such as shape, size, density, and curvature.

The feature classification process may categorize the selected features of the medical image data set into authorized and unauthorized features. The classification aspects of the CAD algorithm may be, partially or fully automated. Bayesian classifiers, neural networks, rule-based methods or fuzzy logic techniques, among others, can be used for classification. It should be noted that more than one CAD algorithm can be employed in parallel. Such parallel operation may involve performing CAD operations individually on portions of the image data, and combining the results of all CAD operations (logically by “and”, “or” operations or both). In addition, CAD operations to detect anatomical features of interest may be performed in series or in parallel. Thus, the operations to detect multiple aspects of legal compliance can be performed in series by incorporating features from all data or can be performed in parallel.

To accommodate scale differences over various images during feature extraction, all extracted features are also normalized over training examples to the same scale. The feature normalization process normalizes the feature measures with respect to measures derived from a database of known authorized and unauthorized regions of interest. Further, the training process may be utilized to train the feature normalization process to enhance the classification process based upon prior knowledge and experiences.

The normalized feature data then undergoes feature categorization whereby the features are grouped or clustered based upon their respective normalized feature measures. The clustered features are then labeled, by the insertion of markers in the code, by the feature labeling.

The result of the feature classification process is a feature-processed data set, which may then undergo feature suppression. The intent of suppression of selected regions is to prevent the unauthorized user from accessing certain sensitive information that they are not privileged while not preventing the unauthorized user from viewing the general information content.

The suppressed feature processed dataset is then provided to the user. Thus, various types of images may be presented to the user, based upon any or all of the processing and modules performed by the CAD algorithm.

System and method for computer assisted analysis of medical image provided in various embodiments of the invention may facilitate detection, suppression, and compliance and/or may also facilitate diagnosis. Subsequent processing is, then, entirely at the discretion and based upon the expertise of the user.

Some of the advantages provided by the system and method for computer assisted analysis of medical image provided in various embodiments of the invention are listed below.

Using medical imaging for gender selection is illegal in some parts of the world such as India and China. The system and method provided in the invention can enable an imaging modality to be legally compliant thereby enabling an imaging modality to overcome image based legal compliance issues.

In general, the system and method provided in the invention can enable a computer system displaying an image to selectively hide the information content in the image being displayed. In one embodiment, a single level of selective suppression can be incorporated prior to providing access to the image. This may result in displaying a single image to all the users, the display limited to general information content of the image. Alternatively, the selective suppression can be dependent on multiple levels of authorization provided to various users. This may result in displaying altered forms of a single image as various images with each altered form displaying a varied level of information content.

In various embodiments of the invention, a system and method for computer assisted analysis of medical image are described. However, the embodiments are not limited and may be implemented in connection with different applications. The application of the invention can be extended to other areas, for example imaging systems, industrial inspection systems, security scanners, particle accelerators, etc. The invention provides a broad concept of processing an image, which can be adapted in a similar imaging system. The design can be carried further and implemented in various forms and specifications.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer assisted method for displaying a medical image, the method comprising steps of:
determining authorization status of a user accessing an image database;
suppressing the information content in a first image, commensurate with the authorization status, to obtain a second image; and
displaying the second image to the user.

2. The method of claim 1, wherein suppressing the information content comprises:
automatically segmenting at least one region of interest in the first image; and suppressing the information content in the region of interest.

3. The method of claim 1, wherein suppressing the information content comprises:
accessing a pre computed segmentation mask corresponding to at least one region of interest, the pre computed segmentation mask stored in the image database; and
suppressing the information content in the region of interest based on the pre computed segmentation mask.

4. The method of claim 3, wherein the pre computed segmentation mask is chosen based on the authorization status.

5. The method of claim 1, wherein suppressing the information content comprises:
altering the first image based on the authorization status; and
suppressing one or more regions of interest in the first image.

6. The method of claim 2, wherein the step of automatically segmenting comprises:
performing feature extraction on the region of interest;
performing feature evaluation on the region of interest; and
performing feature based segmentation for segmenting the region of interest.

7. The method of claim 1, wherein the medical image is obtained from an image database

8. The method of claim 1, wherein the medical image is acquired in real time using an imaging system, the imaging system including an ultrasound imaging system.

9. A method for analyzing a medical image comprising:
acquiring a first image from an imaging system;
determining an authorization status of a user accessing the first image;
suppressing the information content in the first image, commensurate with the authorization status, to obtain a second image; and
displaying the second image to the user.

10. The method of claim 9, wherein acquiring the first image comprises acquiring the first image from an imaging system, the imaging system including an ultrasound imaging system, a computed tomography system, a magnetic resonance imaging system and a positron emission tomography (PET) system.

11. The method of claim 9, wherein suppressing the information content comprises:
automatically segmenting at least one region of interest in the first image; and
suppressing the information content in the region of interest.

12. The method of claim 11, further comprises processing one or more features of the one or more segmented data sets to produce one or more feature-processed data sets, wherein processing one or more features of the one or more segmented data sets comprises extracting one or more features from the one or more segmented data sets.

13. The method of claim 12, wherein processing one or more features of the one or more segmented data sets comprises at least one of:
evaluating the one or more features using a distance criteria;
ranking the features based upon the distance criteria;
eliminating one or more features based upon a degree of correlation; and
optimizing a selected feature set using a performance algorithm.

14. The method of claim 13, further comprising training a processing system to process the one or more features of the one or more segmented data sets.

15. The method of claim 13, further comprising classifying each of the one or more features based upon one or more feature measurements of each feature to produce the one or more feature-processed data sets, wherein classifying the one or more features comprises normalizing the feature measurements based upon a plurality of prior measurements, grouping the one or more features based upon their normalized feature measurements, and labeling the groups of one or more features.

16. The method of claim 9, wherein suppressing the information content comprises:
accessing a pre computed segmentation mask corresponding to at least one region of interest, the pre computed segmentation mask stored in the image database; and
suppressing the information content in the region of interest based on the pre computed segmentation mask.

17. The method of claim 16, wherein the pre computed segmentation mask is chosen based on the authorization status.

18. The method of claim 9, wherein suppressing the information content comprises:
altering the first image based on the authorization status; and
suppressing one or more regions of interest in the first image.

19. A system for computer assisted analysis of medical image, the system comprising:
a source;
a detector;
a data acquisition system;
a computer system operably coupled to the data acquisition system, an operator workstation and a memory element;
wherein the computer system is configured to acquire a first image from the detector;
determine an authorization status of a user accessing the first image;
suppress the information content in the first image, commensurate with the authorization status, to obtain a second image; and
display the second image to the user.

20. The system of claim 19, wherein the computer system is configured to process one or more features of the one or more segmented data sets by extracting one or more features from the one or more segmented data sets.

21. The system of claim 20, wherein the computer system is further configured to evaluate the one or more features using a distance criteria, rank the features based upon the distance criteria, eliminate one or more features based upon a degree of correlation, and optimize a selected feature set using a performance algorithm.

22. The system of claim 21, wherein the computer system is further configured to classify each of the one or more features based upon one or more feature measurements of each feature to produce the one or more feature-processed data sets.

23. The system of claim 22, wherein the computer system is configured to classify the one or more features by normalizing the feature measurements based upon a plurality of prior measurements, group the one or more features based upon their normalized feature measurements, and label the groups of one or more features.

24. A tangible medium comprising program code for executing an image processing method, the tangible medium comprising:
a routine for determining authorization status of a user accessing an image database;
a routine for suppressing the information content in a first image, commensurate with the authorization status, to obtain a second image; and
a routine for displaying the second image to the user.

25. The method of claim 24, wherein the routine for suppressing the information content comprises:
a routine for automatically segmenting at least one region of interest in the first image; and
a routine for suppressing the information content in the region of interest.

26. The method of claim 24, wherein the routine for suppressing the information content comprises:
a routine for accessing a pre computed segmentation mask corresponding to at least one region of interest, the pre computed segmentation mask stored in the image database; and
a routine for suppressing the information content in the region of interest based on the pre computed segmentation mask.

27. The method of claim 26, wherein the pre computed segmentation mask is chosen based on the authorization status.

28. The method of claim 24, wherein suppressing the information content comprises:
a routine for altering the first image based on the authorization status; and
a routine for suppressing one or more regions of interest in the first image.
